(19) United States
(12) Patent Application Publication
(10) Pub. No.: US 2013/0176284 A1
(43) Pub. Date: Jul. 11, 2013

(54) PORTABLE CAPACITIVE TOUCH CONTROL ACCESSORY

(71) Applicant: Hsin-Hung CHUANG, Jhongli City (TW)

(72) Inventor: Hsin-Hung CHUANG, Jhongli City (TW)

(21) Appl. No.: 13/344,002

(22) Filed: Jan. 5, 2012

(51) Int. Cl. G06F 3/033

(52) U.S. Cl. 345/179

(57) ABSTRACT

A portable capacitive touch control accessory comprises a connecting part and a touch control head: the connecting part is a nonconducting tubular element with a bore at one end for the bore adequately coupled with columnar paraphernalia and has at least one partial surface with a conductive layer which is exposed outside the connecting part and accessible to one user; the touch control head, which is conductive and electrically connected to the conductive layer, links the other end of the connecting part via a connecting device. The portable capacitive touch control accessory can be taken as one accessory installed on one user's multiple paraphernalia which is used in operating a capacitive touch panel by means of a touch control head when an electric loop is developed with the touch control head and the body of one paraphernalia user contacting the conductive layer.

### BACKGROUND OF THE INVENTION

1) Field of the Invention

The present invention relates to a capacitive touch control accessory, especially a portable capacitive touch control accessory installed on columnar paraphernalia for the paraphernalia used in operating a capacitive touch panel.

2) Description of the Prior Art

The prosperous electronic industry has accelerated 3C products available in the market wherein touch interfaces have become a trend and mainstream designed on future 3C products. Basically, a touch interface is developed with integration of one graphic operating system (software) and one touch panel (hardware) which can be classified into a resistive touch panel, a capacitive touch panel, an optic touch panel, an electromagnetic touch panel or an ultrasonic touch panel according to its induction theory. The touch panels applied to personal digital assistants or mobile phones initially are resistive touch panels which are cost effective but fail to deliver multi-touch.

In contrast to conventional resistive touch panels effective in single-touch, capacitive touch panels first installed on mobile phones or tablet personal computers of Apple Inc. support multi-touch and provide graphic operation interfaces rich in diversified operation models and funs, earning consumers' universal acceptance and preference, and causing capacitive touch panels to be installed on more and more 3C products.

A capacitive touch panel which is directly operated by fingers is less convenient than a touch pen during touch input, and some users still prefer operating a capacitive touch panel by a pen-like tool. In this regard, a touch pen traditionally used in a resistive touch panel cannot be directly applicable to a capacitive touch panel whose induction is different from that of a resistive touch panel.

With specific shapes and structures, lots of capacitive touch pens exclusively developed for those capacitive touch panels and available in the market belong to independent and function-completed capacitive touch control devices that are not integrated into a user's multiple paraphernalia to which a capacitive touch pen must be added particularly. As a result, a user has to carefully find an easily carried capacitive touch pen in order to reduce personal load.

### SUMMARY OF THE INVENTION

The present invention provides a portable capacitive touch control accessory which can be adequately installed on columnar paraphernalia for the paraphernalia used in operating a capacitive touch panel in view of some users' preference for operating a capacitive touch panel by a pen-like tool and a conventional capacitive touch pen not integrated with a user's multiple paraphernalia

The present invention of a portable capacitive touch control accessory in one embodiment comprises:

A connecting part which is a nonconducting tubular element with a bore at one end for the bore adequately coupled with columnar paraphernalia and has at least one partial surface with a conductive layer exposed outside the connecting part and accessible to one user;

A touch control head which is a conductive pliable or inflexible component; and

A connecting device which is used in connecting the touch control head to the connecting part's other end for the connecting part's conductive layer and the touch control head electrically connected each other.

The portable capacitive touch control accessory can be taken as one accessory installed on one user's paraphernalia which is used in operating a capacitive touch panel by means of a touch control head when an electric loop is developed with the touch control head and the body of one paraphernalia user contacting the conductive layer.

For the structure of the present invention in one embodiment, the connecting part is one flexible elastic component which is manufactured with one nonconducting material in rubber, silicon rubber or plastic.

For the structure of the present invention in one embodiment, there are conductive layers installed on an exterior surface of the connecting part and one surface adjacent to both the connecting part and the touch control head.

For the structure of the present invention in one embodiment, the strips of conductive layers are distributed at the outside corresponding to the axis of the connecting part and a surface adjacent to both the connecting part and the touch control head.

For the structure of the present invention in one embodiment, the conductive layer can be either one metallic layer or metallic paint and developed on at least one partial surface of the connecting part with one method in electroplating, vacuum metalizing, cathode sputtering, metal spraying or coating.

For the structure of the present invention in one embodiment, the touch control head is optionally manufactured with one conductive material in conductive rubber, conductive plastic or conductive foam or with a combination of these materials thereof.

For the structure of the present invention in one embodiment, the connecting device, which is either a threaded structure or a mosaic structure, is effective in the touch control head linking the connecting part's other end and the conductive layer on the connecting part electrically connected to the freely replaceable touch control head.

Furthermore, the said touch control head is coated with one layer of conductive fabric for better conductivity.

It can be seen from above descriptions for the present invention that the present invention of a portable capacitive touch control accessory is installed on one user's columnar paraphernalia (e.g., ball-point pen) by means of a connecting part for an electric loop developed with the touch control head and the body of one paraphernalia user contacting the conductive layer and the paraphernalia used in operating a capacitive touch panel through the touch control head.

The present invention's other functions and embodiments are further illustrated with drawings as follows.

### DETAILED DESCRIPTIONS OF THE PREFERRED EMBODIMENTS

As shown in FIG. 1 which illustrates the structure of the first embodiment, the present invention of a portable capacitive touch control accessory comprises:

A connecting part 10 which is a nonconducting tubular element with a bore 11 at one end for the bore 11 adequately coupled with columnar paraphernalia (as shown in FIG. 9) and has at least one partial surface with a conductive layer 20 exposed outside the connecting part 10 and accessible to one user;

A touch control head 30 which is a conductive pliable or inflexible component; and

A connecting device which is used in connecting the touch control head 30 to the other end of the connecting part 10 for the conductive layer 20 on the connecting part 10 electrically connected to the touch control head 30 and comprises several structures in different embodiments described hereinafter.

The connecting part 10 is an flexible elastic component, which has the bore 11 steadily coupled with columnar paraphernalia or paraphernalia's columnar part, for example, the bore 11 coupled with and not loosened from a ball-point pen (as shown in FIG. 9), an eyebrow pencil or paraphernalia's columnar part, and is manufactured with one nonconducting material in rubber, silicon rubber or plastic.

The touch control head 30 which is a conductive pliable component and used to directly contact a capacitive touch panel for operation is manufactured with one flexible material not damaging a capacitive touch panel such as conductive rubber, conductive plastic or conductive foam or a combination of these materials thereof.

The conductive layer 20 is one metallic layer or metallic paint coated on one surface of the connecting part 10, which is roughened mechanically or chemically for the conductive material such as metallic layer or metallic paint adhered to the roughened surface, and is developed on at least one partial surface of the connecting part 10 with one method in electroplating, vacuum metalizing, cathode sputtering, metal spraying or coating.

In the first embodiment of the present invention, the conductive layers 20 are developed at the outside of the connecting part 10 (FIG. 1) and one surface adjacent to both the connecting part 10 and the touch control head 30 (FIGS. 3 and 8) wherein the touch control head 30 relies on a connecting device to link the other end of the connecting part 10 for the conductive layer 20 on the connecting part 10 electrically connected to the touch control head 30.

In another embodiment, the strips of conductive layers 20 are distributed at the outside corresponding to the axis of the connecting part 10 (FIG. 4) and the outside thereof is not limited to both locations in FIG. 6 (i.e., arrows A1 and A2) and regarded as other external positions corresponding to the axis other than those two locations.

The connecting device can be either a threaded structure as shown in FIG. 2 or a mosaic structure as shown in FIGS. 5 and 7 for the touch control head 30 installed at the other end of the connecting part 10 and electrically connected to the conductive layer 20 on the connecting part 10 or freely replaced by another touch control head 30a (FIG. 7). Illustrated in drawings, the structures of several connecting devices in embodiments are shown as follows.

For threaded structures of embodiments in FIGS. 2 and 3, a first thread 12 is prepared on the bottom of the connecting part 10 and a corresponding second thread 31 is designed on the top of the touch control head 30 wherein the first thread 12 and the second thread 31 can be a male thread (female thread) and a female thread (male thread), respectively, both of which can be used to link the touch control head 30 at the other end of the connecting part 10 for the conductive layer 20 on the connecting part 10 electrically connected to the touch control head 30.

For mosaic structures of embodiments in FIGS. 5 and 6, a groove 13 is designed around the circumferential edge of the connecting part 10 and at one location close to the touch control head 30, which is provided with (a) an interface 32 at the top for the interface 32 coupled with the bottom of the connecting part 10 and (b) a rib 33 on the inner surface of the interface 32 protruding toward the center of the interface 32, wherein the touch control head 30 as one conductive pliable component allows its interface 32 to be easily coupled with the bottom of the connecting part 10 (FIG. 1) for the rib 33 embedded into the groove 13 on the connecting part 10 and both the touch control head 30 and the conductive layer 20 electrically connected. Additionally, the touch control head 30 can be removed and replaced by another touch control head 30a with a different shape, for instance, the touch control head 30a as shown in FIG. 7, according to one user's requirement.

For mosaic structures of embodiments in FIGS. 7 and 8, a rib 14 located at an inner surface of the connecting part 10 and protruding toward the center is close to the touch control head 30 which is provided with a concave groove 34 at its top circumferential edge wherein the touch control head 30 as one conductive pliable component allows its groove 34 to be easily embedded into the rib 14 on the connecting part 10 for both the touch control head 30 and the conductive layer 20 electrically connected.

Furthermore, the said touch control head 30 is coated with one layer of conductive fabric for better conductivity.

The said connecting device can be delivered with slight changes or other equivalent structures by any person who is skilled in the art and familiar with structures described in embodiments for several connecting devices. However, these simple changes still belong to the technical scope of the present invention.

Notwithstanding the foregoing disclosures for embodiments of the present invention, the embodiments are not used in restricting the present invention and any person skilled in the arts could make some changes without departing from spirit and scope of the present invention. Accordingly, the scope of patent protection for the present invention will depend on claims in the patent specifications.

### BRIEF DESCRIPTIONS OF THE DRAWINGS

FIG. 1 illustrates the structure of a portable capacitive touch control accessory in one embodiment of the present invention.

FIG. 2 is the explosive view corresponding to FIG. 1 and illustrates correlations between all components.

FIG. 3 is the cross-sectional view about the cutting plane line III-III in FIG. 2 and illustrates the structure of a conductive layer and a connecting device in one embodiment.

FIG. 4 illustrates the structure of a portable capacitive touch control accessory in another embodiment of the present invention.

FIG. 5 is the explosive view corresponding to FIG. 4 and illustrates correlations between all components.

FIG. 6 is the cross-sectional view about the cutting plane line VI-VI in FIG. 5 and illustrates the structure of a conductive layer and a connecting device in another embodiment.

FIG. 7 illustrates the structure of the present invention in another embodiment and illustrates correlations between all components.

FIG. 8 is the cross-sectional view about the cutting plane line VIII-VIII in FIG. 7 and illustrates the structure of a connecting device in another embodiment.

FIG. 9 is the schematic diagram illustrating usage of the present invention of one portable capacitive touch control accessory in which there is a connecting part coupled with a ball-point pen.

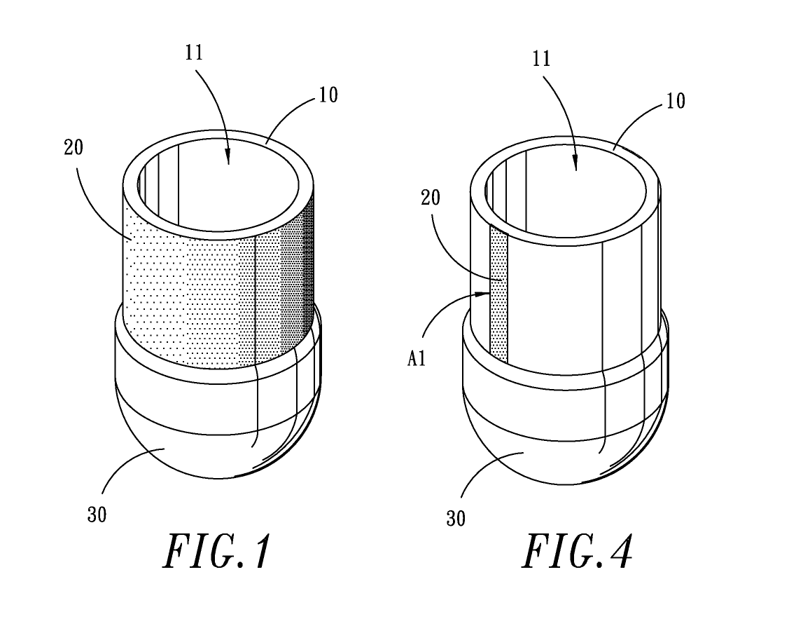

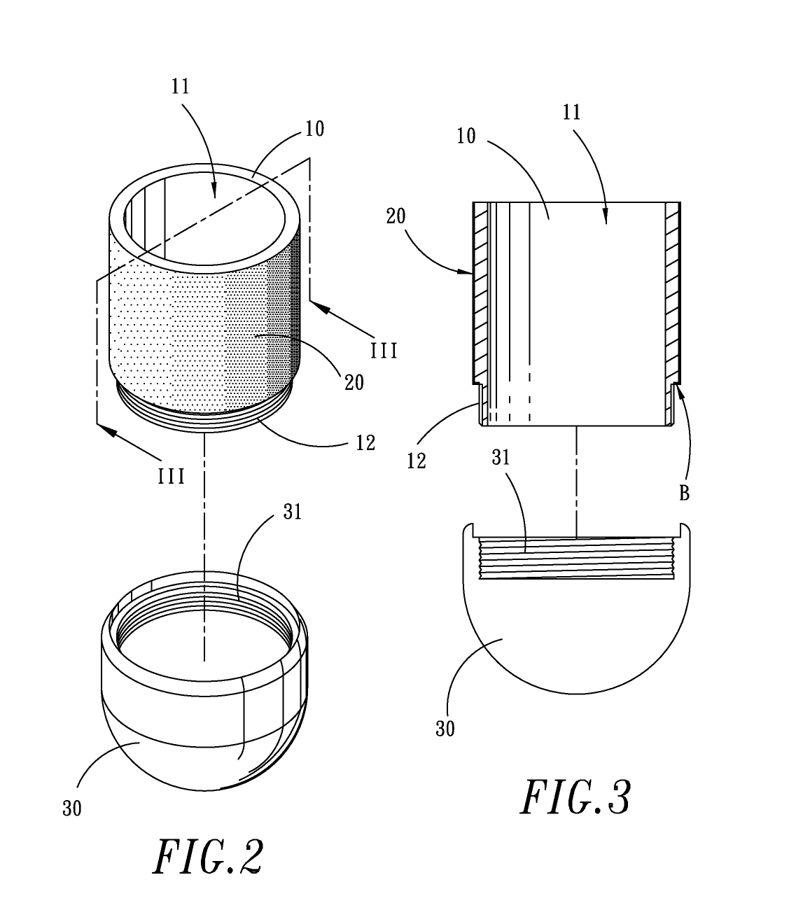

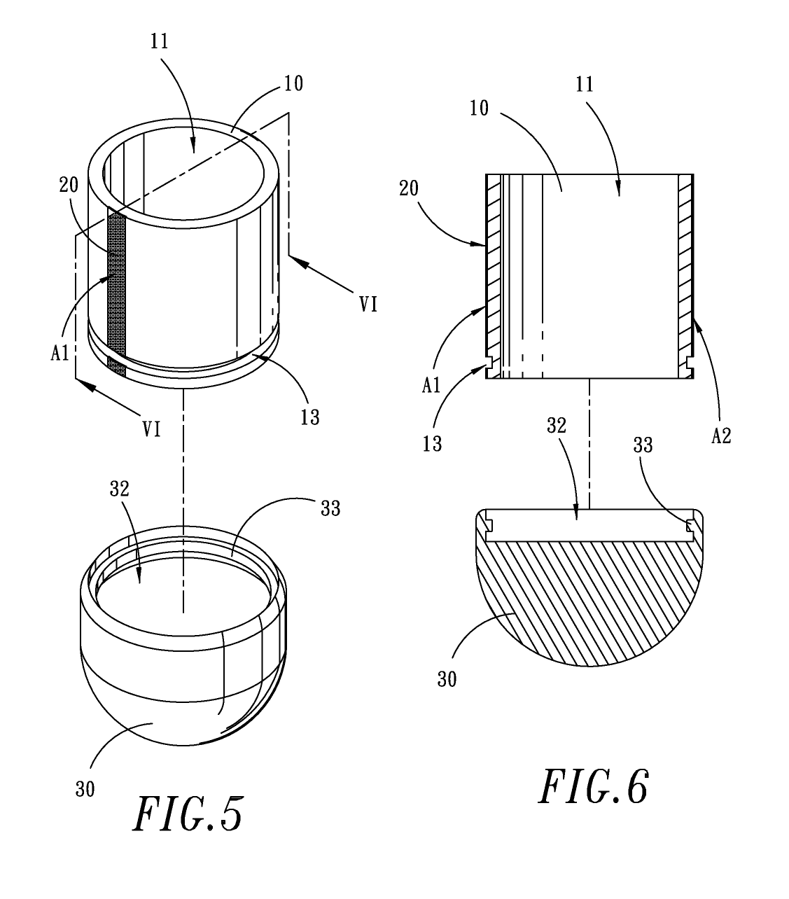

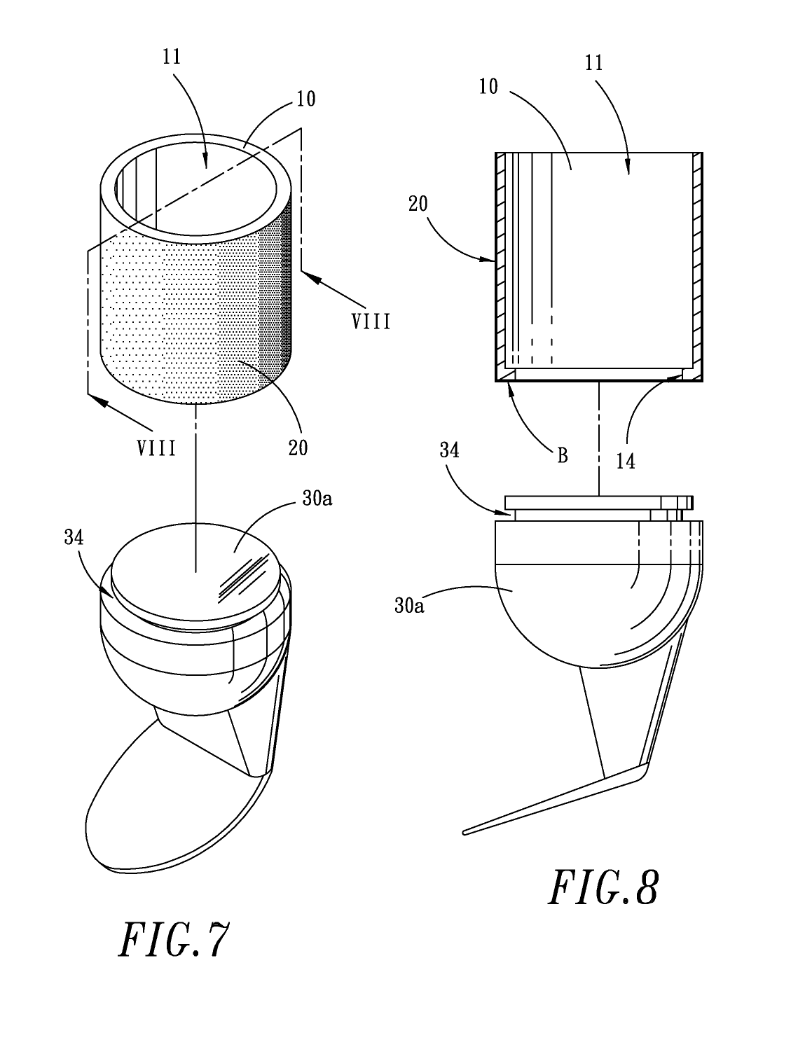

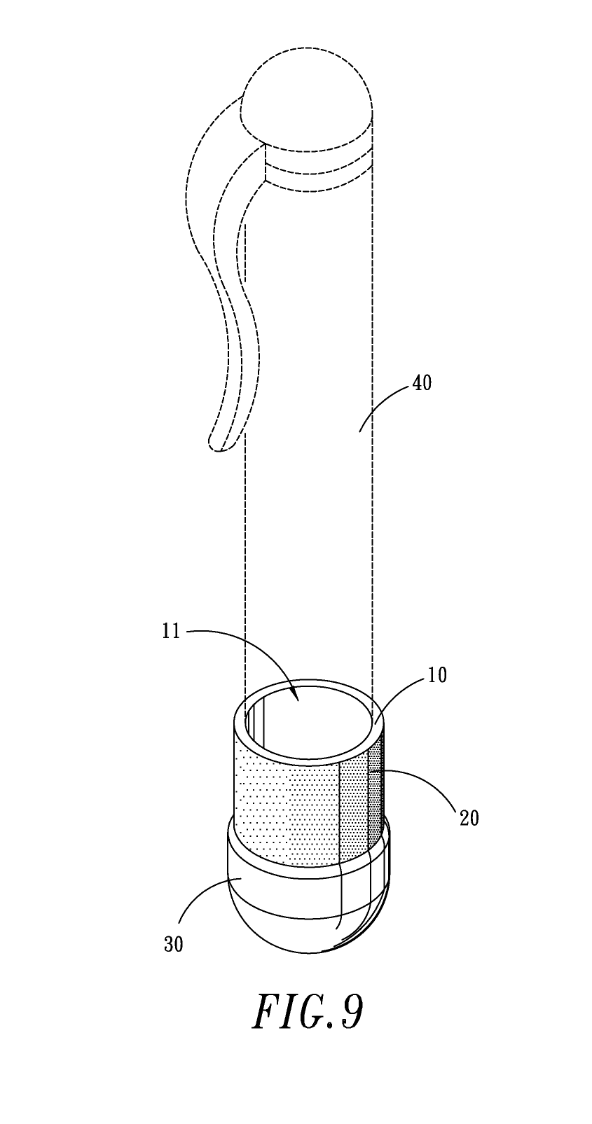

### DESCRIPTION OF REFERENCE CHARACTERS OF IMPORTANT PARTS

10 Connecting Part
11 Bore
12 First Thread
13 Groove
14 Rib
20 Conductive Layer
30 Touch Control Head
30a Touch Control Head
31 Second Thread
32 Interface
33 Rib
34 Groove
40 Ball-Point Pen
A1 Outside corresponding to the axis of the connecting part
A2 Outside corresponding to the axis of the connecting part
B Surface adjacent to a connecting part and a touch control head

What is claimed is:

1. A portable capacitive touch control accessory, which is adequately installed on columnar paraphernalia, comprising:
A connecting part which is a nonconducting tubular element with a bore at one end and has at least one partial surface with a conductive layer exposed outside the connecting part and accessible to one user;
A touch control head which is a conductive component and connected to the connecting part's other end via a connecting device for the conductive layer on the connecting part electrically connected to the touch control head.

2. The portable capacitive touch control accessory according to claim 1 wherein the connecting part is one flexible elastic component which is manufactured with one nonconducting material in rubber, silicon rubber or plastic.

3. The portable capacitive touch control accessory according to claim 1 wherein the touch control head is one conductive pliable or inflexible component which is manufactured with one conductive material in conductive rubber, conductive plastic or conductive foam or with a combination of these materials thereof.

4. The portable capacitive touch control accessory according to claim 1 wherein the conductive layer can be one metallic layer, metallic paint or other conductive materials and developed on at least one partial surface of the connecting part with one method in electroplating, vacuum metalizing, cathode sputtering, metal spraying or coating.

5. The portable capacitive touch control accessory according to claim 4 wherein the conductive layers are developed at an exterior surface of the connecting part and one surface adjacent to both the connecting part and the touch control head.

6. The portable capacitive touch control accessory according to claim 4 wherein the strips of conductive layers are distributed at the outside corresponding to the axis of the connecting part.

7. The portable capacitive touch control accessory according to claim 1 wherein the connecting device is one threaded structure, which has a first thread at the bottom of the connecting part, and the touch control head is provided with a second thread at the top for both the first thread on the connecting part and the second thread on the touch control head screwed each other.

8. The portable capacitive touch control accessory according to claim 1 wherein the connecting device is one mosaic structure and has a groove designed around the circumferential edge of the connecting part and at one location close to the touch control head, which is provided with (a) an interface at the top for the interface coupled with the bottom of the connecting part and (b) a rib being on the inner surface of the interface and protruding toward the center of the interface for the rib embedded into the groove on the connecting part.

9. The portable capacitive touch control accessory according to claim 1 wherein the connecting device is one mosaic structure and a rib being on the inner surface of the connecting part and protruding toward the center is adjacent to the touch control head, which is provided with one concave groove at the top circumferential edge for the groove on the touch control head embedded into the rib on the connecting part.

10. The portable capacitive touch control accessory according to claim 1 wherein the touch control head is coated with one layer of conductive fabric.
